(19) United States
(12) Patent Application Publication
(10) Pub. No.: US 2016/0352100 A1
(43) Pub. Date: Dec. 1, 2016

(54) Vehicle Modular Power System

(71) Applicants: John C. Cheng, City of Industry, CA (US); Joseph S. Chu, City of Industry, CA (US)

(72) Inventors: John C. Cheng, City of Industry, CA (US); Joseph S. Chu, City of Industry, CA (US)

(21) Appl. No.: 14/725,344

(22) Filed: May 29, 2015

(51) Int. Cl. H02J 1/06

(52) U.S. Cl. CPC H02J 1/06; H02J 2001/008

(57) ABSTRACT

A vehicle modular power system (VMPS) consisting of a central power distribution module having attached a selectable plurality of first and second side modules and their corresponding termination modules. The modules can be configured with a plurality of electrical power receptacles and/or USB connectors. The central power distribution module also has attached a cigarette lighter plug that is plugged into a vehicle-attached cigarette lighter receptacle that is connected to a vehicle 12-volts d-c power source. When the plug is plugged into the receptacle, the VMPS is enabled.

### TECHNICAL FIELD

The invention generally pertains to vehicle electrical power systems, and more particularly to a vehicle modular power system (VMPS) that includes a cigarette plug that is inserted into a vehicle's cigarette lighter receptacle. The VMPS can be configured to provide a selectable plurality of electrical power receptacles and/or Universal Serial Bus (USB) connectors.

### BACKGROUND ART

Many vehicles have a single cigarette lighter receptacle that is located in the vicinity of the vehicle's dashboard and that when activated by a cigarette lighter plug, the receptacle produces a 12-volt d-c output. Since there is only one cigarette lighter receptacle only a single electrical accessory can be inserted into the receptacle at any one time. The electrical accessories include but are not limited to lights, fans, and small motorized equipment such as gas compressors for inflating tires. Many portable electronic devices such as music players or mobile telephones can also use the cigarette lighter receptacle to recharge their internal batteries or to be directly operated from the vehicle electrical power system.

USB is an industry standard that defines cables, connectors and communication protocols. USB connectors are designed to standardize the connection of computer peripherals to personal computers, both to communicate and to supply electrical power. USB has effectively replaced a variety of earlier interfaces, such as serial and parallel ports, as well as separate power chargers for portable devices.

A search of the prior art did not disclose any U.S. or International Patents or industry literature that read directly on the claims of the instant patent application.

### DISCLOSURE OF THE INVENTION

The Vehicle Modular Power System (VMPS) is designed to expand a vehicle's singularly available 12-volt d-c power outlet receptacle to a plurality of power outlet receptacles including a plurality of Universal Serial Bus (USB) connectors. In its basic design configuration the VMPS is comprised of:

A. A 12-volt cigarette lighter plug that includes a first end and a second end, each having a + contact and a − contact. The first end is inserted into and makes electrical contact with the + and − contacts located on the vehicle's cigarette lighter receptacle.

B. A central power distribution module comprising a rear panel, a front panel, a right side panel, a left side panel, an upper panel and a lower panel. The rear panel has a power input receptacle having a + contact and a − contact and is dimensioned to receive and make electrical contact with the + and − contacts on the second end of the vehicle's cigarette lighter receptacle. The front panel is translucent and is designed to include either a pair of electrical power output receptacles or a pair of USB connectors. Each receptacle or connector has a + contact and a − contact that are in electrical contact with the + contact and the − contact on the power input receptacle. The right side panel and the left side panel each have a first section of a module interface connector and a first set of + and − contacts. The upper panel and the lower panel in combination enclose the central power distribution module.

C. A first side module and a second side module each comprising a front panel, a first side panel, a second, side panel, an upper panel, a lower panel and a rear panel. The front panel has a set of USB connectors each having a + input and a − input that interface respectively with the + and − contacts located on the first side panel on the central power distribution module. The first and second side panels each have a + contact, a − contact, and the first side of a module interface connector that interfaces with the second side of the module interface connector located respectively on the first and second side panels of the central power distribution module. The upper panel, the lower panel and the rear panel in combination enclose the first and the second side modules.

D. A right side and a left side termination module each comprising a front panel, a rear panel, a first side panel, a second side panel, an upper panel and a lower panel that in combination enclose the right and left side termination module. The front panel includes a module interface connector that interfaces with the interface connector on said second side module, and a set of electrical contacts that interface with the pair of contacts also located on the second side module. When power is available at the vehicle cigarette lighter receptacle and the cigarette lighter plug is inserted into the receptacle, all the modules comprising said VMPS are enabled.

The front panels of the central power distribution module and the side panels can be designed to have either a first and a second electrical output receptacle or a pair of USB connectors. Also, the front panels can be solid or made of a colored translucent plastic.

In view of the above disclosure, the primary object of the invention is to produce a VMPS that allows a person located within a vehicle to directly and selectively access a plurality of power outlet receptacles and/or a plurality of USB connectors. The VMPS also includes a cable assembly that allows the VMPS to be remotely at a distance from the vehicle's cigarette receptacle, for example, by a person sitting in the backseat of a vehicle.

In addition to the primary object of the invention it is also an object of the invention to provide an invention that:
can be dimensioned to accommodate a particular vehicle,
can supply power to various different devices,
is easy to use
can be retro-fitted to existing vehicles or can be included as an OEM component of a new vehicle,
can be made in various colors, and
is cost effective from both a manufacturer's and consumer's point of view.

These and other objects and advantages of the present invention will become apparent from the sub sequent detailed description of the preferred embodiment and the appended claims taken in conjunction with the accompanying drawings.

### BRIEF DESCRIPTION OF THE DRAWINGS

FIG. 1 is a top plan view of a vehicle modular power system (VMPS) having a central power distribution module having a first and a second side module to which are attached a termination module.

FIG. 2 is a front elevational view of the VMPS shown in FIG. 1.

FIG. 3 is an elevational side view showing a first section of a slide-lock module interface connector.

FIG. 4 is an elevational side view showing a second section of a slide-lock module interface connector.

FIG. 5 is a wiring/block diagram of the VMPS shown attached to a cigarette lighter receptacle.

FIG. 6 is an exploded front orthographic view of the VMPS.

FIG. 7 is an orthographic view of a cable assembly that allows the VMPS to be operated remotely.

FIG. 8 is a block diagram showing the interface of the cable assembly with the cigarette lighter receptacle attached to the vehicle power system.

### BEST MODE FOR CARRYING OUT THE INVENTION

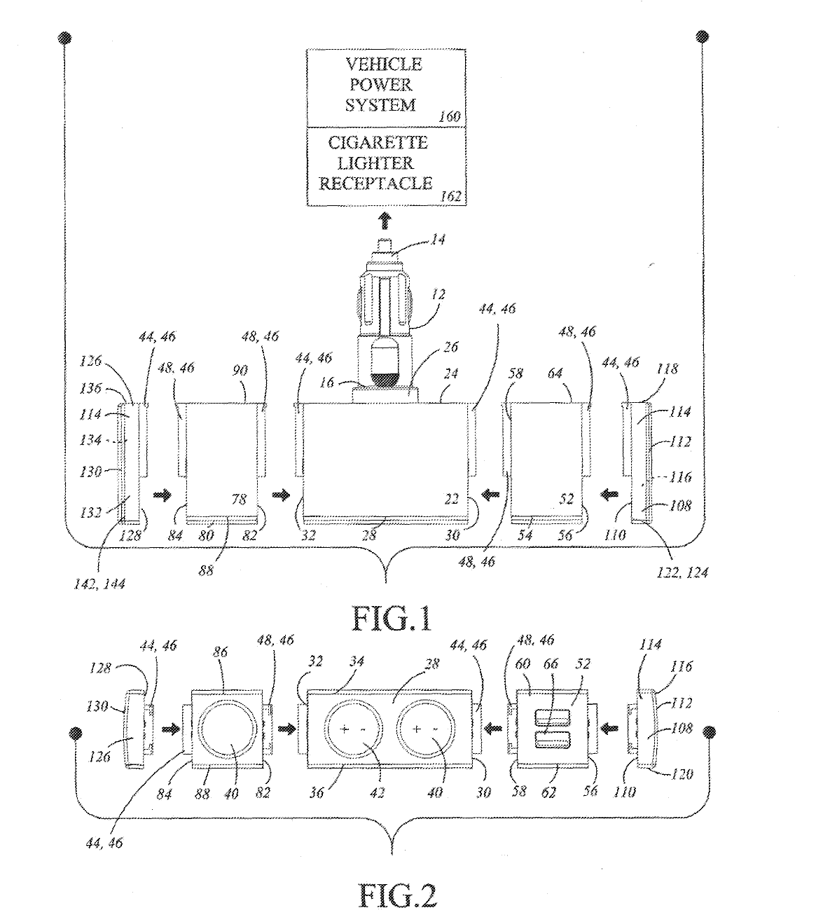

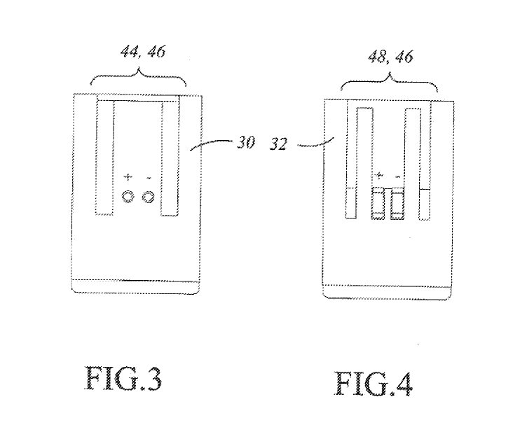

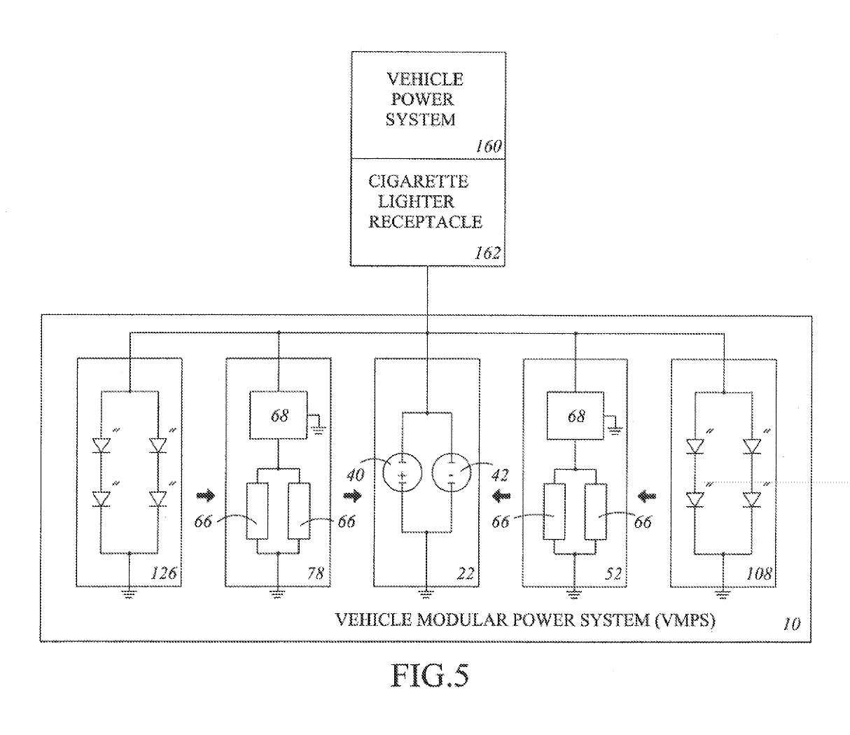

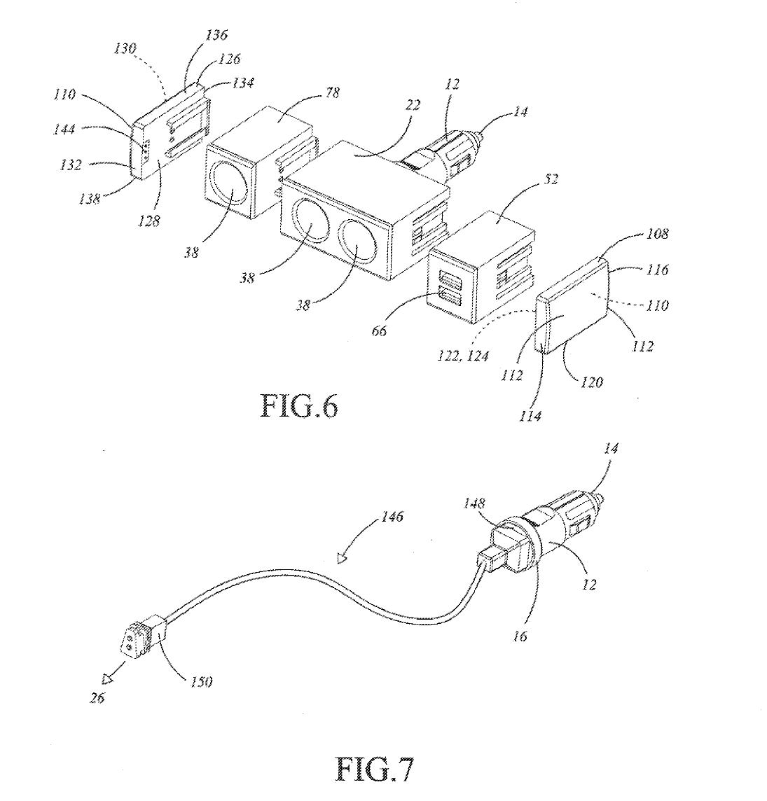

The best mode for carrying out the invention is presented in terms that disclose a preferred embodiment of a Vehicle Modular Power System 10 (VMPS 10) that is enabled when connected to a vehicle-supplied 12-volts d-c. The preferred embodiment, as shown in FIGS. 1-8, is comprised of the following major elements: a cigarette lighter plug 12, a central power distribution module 22, a first side module 52, a second side module 78, a right side termination module 108, a left side termination module 126, and an optional cable assembly 146 that allows the VMPS 10 to be operated at a remote location. The major elements function in combination with a vehicle power system 160 that interfaces with a cigarette lighter receptacle 162 having a first + contact connected to 12-volts d-c and a second − contact connected to circuit ground.

The VMPS 10 is designed to function, with the central power distribution module 22 that has a plurality of first and second side modules 52,78 and their corresponding right and left side termination modules 108,126. However, to present a concise description of the VMPS 10, a central power distribution module 22 that has, only a single first side module 52 and second side module 78 and their corresponding right and left side termination modules 108,126 will be described and shown in FIGS. 1 and 2.

The 12-volt cigarette lighter plug 12, which functions as the interface between the VMPS 10 and the vehicle's cigarette lighter receptacle 162, includes a first end 14 having a + contact and a − contact. The first end 14, as shown in FIG. 1, is dimensioned to be lockably-inserted into and to make electrical contact with the + and − contacts located on the vehicle's cigarette lighter receptacle 162. The plug 12 also has a second end 16 that has a + contact and a − contact that are extensions of the + and − contacts located on the first end 14 of the plug 12.

The central power distribution module 22, as shown in FIGS. 1, 2 and 6, functions as the core of the VMPS 10 and is comprised of a rear panel 24, a front translucent panel 28, a right side panel 30, a left side panel 32, an upper panel 34, and a lower panel 36.

The rear panel 24 has a power input receptacle 26 having a + contact and a − contact and is dimensioned to receive and make electrical contact with the + and − contacts located on the second end 16 of the cigarette lighter plug 12, The front translucent panel 28 has a first power output receptacle 40 and a second power output receptacle 42. Each of the power output receptacles 40,42 include a + contact and a − contact that are in electrical contact with the + contact and the − contact on the power-input receptacle 26. The right side panel 30, as shown in FIGS. 1, 2, 3 and 4, has attached a first section 44 of a slide-lock module interface connector 46 and a first set of + and − contacts. Likewise, the left side panel 32 has a second section 48 of a slide-lock module interface connector 46 and a first set of + and − contacts.

The first side module 52, as shown in FIGS. 1, 2 and 6, is comprised of a front translucent panel 54, a first side panel 56, a second side panel 58, an upper panel 60, a lower panel 62 and a rear panel 64. The front translucent panel 54 includes a set of USB connectors 66, as shown in FIG. 2, that are connected in series with a voltage reduction circuit 68, as shown in FIG. 5, that can be designed to produce an output voltage ranging from 3 to 7-volts d-c. The circuit 68 has a + input and a − input that interfaces respectively with the + and − contacts located on the right side panel 30 of the central power distribution module 22. The first side panel 56 has a + contact, a − contact, and the second section 48 of a slide-lock module interface connector 46. The second side panel 58 has a + contact, a − contact, and the second section of a slide-lock module interface connector 46 that interfaces with the first section 44 of the slide-lock module interface connector 46 located on the right side panel 30 of the central power distribution module 22. The upper panel 60, the lower panel 62 and the rear panel 64 in combination enclose the first side module 52.

The second side module 78, as also shown in FIGS. 1, 2 and 6, is comprised of a front translucent panel 80, a first side panel 82, a second side panel 84 an upper panel 86, a lower panel 88, and a rear panel 90. The front translucent panel 80 has a set of power output receptacles 40 or a set of USB connectors 92, as shown in FIG. 7, that are connected in series with a voltage reduction circuit 96. The circuit 96 has a + input and a − input that interface respectively with the + and − contacts located on the left side panel 32 on the central power distribution module 22. The first side panel 82 has a + contact, a − contact and the second section 48 of a slide-lock module interface connector 46. The second side panel 84 has a + contact, a − contact, and the second section 48 of a slide-lock module interface connector 46. The upper panel 86, the lower panel 88 and the rear panel 90 in combination enclose the second side module 78.

The right side termination module 108, as also shown in FIGS. 1, 2 and 6, is comprised of a front panel 110, a rear panel 112, a first side panel 114, a second side panel 116, an upper panel 118 and a lower panel 120 that in combination enclose the right side termination module 108. The front panel 110 includes a + and a − contact and an upper edge 122 having an LED cavity 124 that encloses a plurality of LEDs that are aligned with the upper edge of the first side module 52. The LEDs are connected in a series-parallel configuration across + and − voltages provided by the first side module 52. Extending from the front panel 110 is the first section 44 of the slide-lock module interface connector 46 that interfaces with the second section 48 of the slide-lock module interface connector 46 located on the first side module 52.

The left side termination module 126, as shown in FIGS. 1, 2, and 6, is comprised of a front panel 128, rear panel 130, a first side panel 132, a second side panel 134, an upper panel 136 and a lower panel 138 that in combination enclose the left side termination module 126. The front panel 128 includes a + contact, a − contact and an upper edge 142 having an LED cavity 144 that partially encloses a plurality of LEDs that are aligned with an upper edge of the second side module 78. The LEDs are connected in a series-parallel configuration across + and − voltages provided by the second side module 78. The front panel 128 has attached the first section 44 of a slide-lock module interface connector 46 that interfaces with the second section 48 of the slide-lock interface connector 46 attached to the second side panel 84 of the second side module 78. When power is available at the vehicle's cigarette lighter receptacle 162 and the cigarette lighter plug 12 is inserted into the vehicle's cigarette receptacle 162, all the modules comprising the VMPS 10 are enabled together with the plurality of LEDs which illuminate the front panels of the module's front translucent panels which can be designed to have either a pair of electrical output receptacles or a pair of USB connectors. Additionally, the front translucent panels are preferably tinted in a color that is selected from the group consisting blue, red, yellow and green.

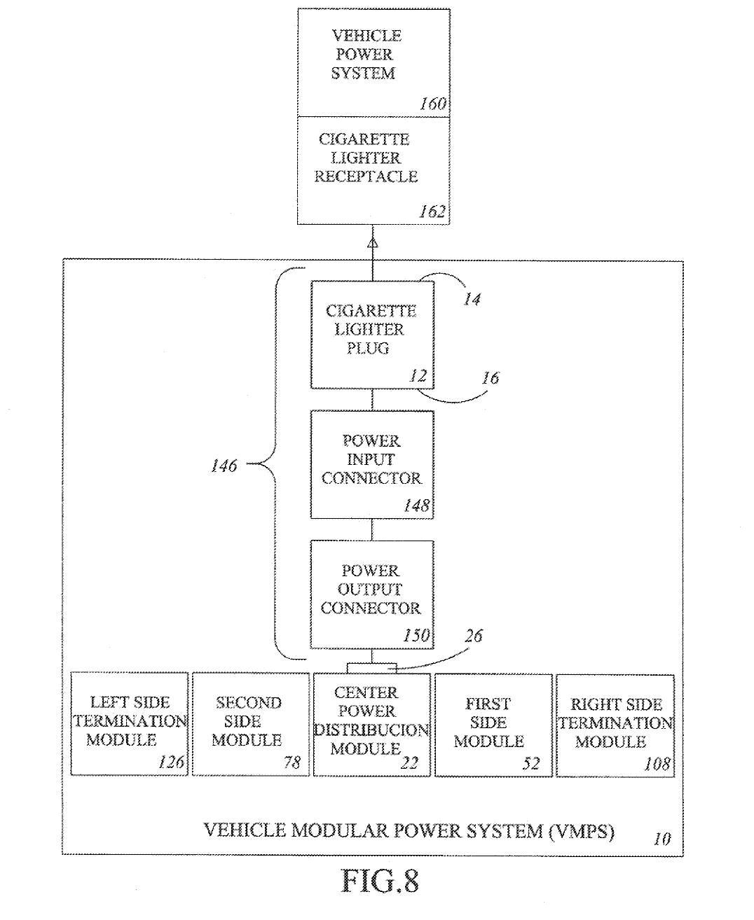

The final element that comprises the VMPS 10 is the cable assembly 146 that has attached, as shown in FIGS. 7 and 8, a power input connector 148 and a power output connector 150. The power input connector 148 is attached to the second end 16 of the cigarette lighter plug 12 which, in turn, has a first end 14 that plugs into the vehicle's cigarette lighter receptacle 162. The power output connector 150 is inserted into the power input receptacle 26 located on the rear panel 24 of the central power distribution panel 22, wherein the cable assembly 146 allows the VMPS 10 to be operated at a distance from the vehicle's cigarette receptacle, for example, by a person sitting in the backseat of a vehicle.

While the invention has been described in detail and pictorially shown in the accompanying drawings it is not to be limited to such details, since many changes and modification may be made to the invention without departing from the spirit and the scope thereof. For example, in an alternate embodiment, the VMPS 10 can have a front panel that is not translucent and does not include/utilize LEDs. Hence, it is described to cover any and all modifications and forms which may come within the language and scope of the claims.

1. A vehicle modular power system (VMPS) that functions in combination with a vehicle power system that has a-cigarette lighter receptacle having a first + contact connected to 12 volts d-c and a second − contact connected to circuit ground, wherein said VMPS comprises:
a) a 12-volt cigarette lighter plug that includes a first end having a + contact and a − contact, wherein the first end is dimensioned to be inserted into and to make electrical contact with the + and − contacts located on the vehicle's cigarette lighter receptacle, wherein the second end of said plug also has a + contact and a − contact,
b) a central power distribution module comprising:
(1) a rear panel having a power input receptacle having a + contact and a − contact, and is dimensioned to make electrical contact with the + and − contacts on the second end of said cigarette lighter plug,
(2) a front panel that is designed to include either a pair of electrical power output receptacles or a pair of USB connectors, wherein each receptacle or connector has a + contact and a − contact that are in electrical contact with the + contact and the − contact on the power input receptacle,
(3) a right side panel having a first section of a module interface connector and a first set of + and − contacts,
(4) a left side panel having a first section of a module interface connector having a second set of + and − contacts,
(5) an upper panel and a lower panel that in combination enclose said central power distribution module,
c) a first side module comprising:
(1) a front panel having a set of USB connectors, each having a + input and a − input that interface respectively with the + and − contacts located on the first side panel on said central power distribution module,
(2) a first side panel having a + contact, a − contact, and the first side of a module interface connector that interfaces with the second side of the module interface connector on the first side panel of said central power distribution module,
(3) a second side panel having a + contact, a − contact, and the first side of a module interface connector that interfaces with the second side of the module interface connector on the second side panel of said central power distribution module,
(4) an upper panel, a lower panel and a rear panel that in combination enclose said first side module,
d) a second side module comprising;
(1) a front panel having a set of USB connectors, each having a + input and a − input that interface respectively with the + and − contacts located on the second side panel on said central power distribution module,
(2) a first side panel having a + contact, a − contact, and the first side of a module interface connector that interfaces with the second side of the module interface connector located on the first side panel of said central power distribution module,
(3) a second side panel having a + contact; a − contact, and the first side of a module interface connector that interfaces with the second side of the module interface connector located on the second side panel of said central power distribution module,
(4) an upper panel, a lower panel and a rear panel that in combination enclose said first side module,
(e) a second side module comprising:
(1) a front panel having a set of USB connectors having a + input and a − input that interface respectively with the + and − contacts located on the second side panel on said central power distribution module,
(2) a first side panel having a + contact, a − contact, and the first side of a module interface connector that interfaces with the second side of the module interface connector located on the second side panel of said central power distribution module,
(3) a second side panel having a + contact; a − contact, and the first side of a module interface connector that interfaces with the second side of the module interface connector on the second side panel of said central power distribution module,
(4) an upper panel, a lower panel and a rear panel that in combination enclose said second side module,
(f) a right side termination module comprising a front panel, a rear panel, a first side panel, a second side panel, an upper panel and a lower panel that in combination enclose said right side termination module, wherein the front panel includes a module interface connector that interfaces with the interface connector on said first side panel, and a pair of electrical contacts that interface with the contacts on said first side module, wherein the front panel includes a pair of electrical contacts that interface with the pair of contacts on said first side module, and
(g) a left side termination module comprising a front panel, a rear panel, a first side panel, a second side panel, an upper panel and a lower panel that in combination enclose said left side termination module, wherein the front panel includes a module interface connector that interfaces with the interface connector on said second side module, and a set of electrical contacts that interface with the pair of contacts on said second side module, wherein when power is available at the vehicle cigarette lighter receptacle and said cigarette lighter plug is inserted into the receptacle, all the modules comprising said VMPS are enabled.

2. The VMPS as specified in claim 1 wherein the front panel is designed to have either a first and a second electrical output receptacles or a pair of USB output connectors.

3. The VMPS as specified in claim 1 wherein the front translucent front panels are made of a translucent plastic.

4. The VMPS as specified in claim 3 wherein said translucent front panels are color tinted.

5. The VMPS as specified in claim 4 wherein the color tint is selected from the group consisting blue, red, yellow and green.

6. The VMPS as specified in claim 1 wherein the module interface connector is comprised of a pair of slide lock module interface connectors.

7. The VMPS as specified in claim 1 wherein said voltage reduction circuit is designed to produce a voltage ranging from 3 to 7-volts d-c.

8. The VMPS as specified in claim 1 further comprising a cable assembly having a power input connector and a power output connector, wherein the power input connector is attached to the second end of the cigarette lighter plug which has a first end that plugs into the vehicles cigarette lighter receptacle, wherein the power output connector is inserted into the power input receptacle located on the rear panel of said central power distribution panel, wherein said cable assembly allows said VMPS to be operated at a distance from the vehicle's cigarette receptacle, for example, by a person sitting in the backseat of a vehicle.

9. A vehicle modular power system (VMPS) that functions in combination with a vehicle power system that has attached a cigarette lighter receptacle having a first contact connected to + 12-volts d-c and a second contact connected to − circuit ground, wherein said VMPS comprises:
a) a 12-volt cigarette lighter plug that includes a first end having a + contact and a − contact, wherein the first end is dimensioned to be lockably-inserted into and make electrical contact with the + and − contacts located on the vehicle's cigarette lighter receptacle, wherein the second end of said plug has a + contact and a − contact that are extensions of the + and − contacts located on the first end of said plug,
b) a central power distribution module comprising:
(1) a rear panel having a power-input receptacle having a + contact and a − contact, and that is dimensioned to receive and make electrical contact with the + and − contacts located on the second end of said cigarette lighter plug,
(2) a front translucent panel having a first electrical power output receptacle and a second electrical power output receptacle; wherein each output receptacle has a + contact and a − contact that are in electrical contact with the + contact and the − contact on the power-input receptacle
(3) a right side panel having attached a first section of a slide-lock module interface connector and a first set of + and − contacts,
(4) a left side panel also having attached a first section of a slide-lock module interface connector and a second set of + and − contacts,
(5) an upper panel and a lower panel that in combination enclose said central power distribution module,
c) a first side module comprising:
(1) a front translucent panel having a pair of USB connectors that are connected in series with a voltage reduction circuit having a + input and a − input that interface respectively with the + and − contacts located on the first side panel located on said central power distribution module,
(2) a first side panel having a + contact, a − contact, and a second section of a slide-lock module interface connector,
(3) a second side panel having a + contact, a − contact and a second section of a slide-lock module interface connector that interfaces with the first section of the slide-lock module interface connector attached to the first side panel of said central power distribution module,
(4) an upper panel, a lower panel and a rear panel that in combination enclose said first side module,
d) a second side module comprising;
(1) a front translucent panel having a set of USB connectors that are connected in series with a voltage reduction circuit having a + input and a − input that interface respectively with the + and − contacts located on the second side panel located on said central power distribution module,
(2) a first side panel having a + contact, a − contact, and a second section of a slide-lock module interface connector that interfaces with the first section of the slide-lock module interface connector attached to the second side panel of said central power distribution module,
(3) a second side panel having a + contact; a − contact, and the second section of a slide-lock module interface connector,
(4) an upper panel, a lower panel and a rear panel that in combination enclose said first side module,
e) a right side termination module comprising;
(1) a rear panel, a first side panel, a second side panel, an upper panel and a lower panel that in combination enclose said right side termination module,
(2) a front panel that includes an upper edge having an LED cavity that encloses a plurality of LEDs that are aligned with an upper edge of said first side module, wherein said LEDs are connected in a series-parallel configuration across a + and − voltage, wherein the front panel has attached a first section of a slide-lock module interface connector that interfaces with the second section of the slide-lock interface connector attached to the first side panel on the first side module,
f) a left side termination module comprising;
(1) a rear panel, a first side panel, a second side panel, an upper panel and a lower panel that in combination enclose said left side termination module, and
(2) a front panel that includes an upper edge having an LED cavity that partially encloses a plurality of LEDs that are aligned with an upper edge of said second side module, wherein said LEDs are connected in a series-parallel configuration across a + and − voltage, wherein the front panel has attached the first section of a slide-lock module interface connector that interfaces with the second section of the slide-lock interface connector attached to the second side panel of the second side module, wherein when power is available at the vehicle cigarette lighter receptacle and said cigarette lighter plug is inserted into the receptacle, all the modules comprising said VMPS are enabled together with said plurality of LEDs which illuminate the front panels of said modules.

10. The VMPS as specified in claim 9 wherein the front panel is designed to have either a first and a second electrical output receptacles or a pair of USB output connectors.

11. The VMPS as specified in claim 9 wherein the front translucent panels are color tinted.

12. The VMPS as specified in claim 11 wherein the color tint is selected from the group consisting of blue, red, yellow and green.

13. The VMPS as specified in claim 9 further comprising a cable assembly having a power input connector and a power output connector, wherein the power input connector is attached to the second end of the cigarette lighter plug which has a first end that plugs into the vehicles cigarette lighter receptacle, wherein the power output connector is inserted into the power input receptacle located on the rear panel of said central power distribution panel, wherein said cable assembly allows said VMPS to be operated at a distance from the vehicle's cigarette receptacle, for example, by a person sitting in the backseat of a vehicle.
